(19) United States
(12) Patent Application Publication
(10) Pub. No.: US 2007/0033308 A1
(43) Pub. Date: Feb. 8, 2007

(54) USB apparatus capable of automatically detecting a USB mode and the method thereof

(75) Inventors: Kuei-Chun Teng, Hsinchu (TW); Ming-Zhe Liu, Sindian City (TW); Ong Keng Khai, Hsinchu (TW); Yee-Lu Zhaog, Hsinchu City (TW)

Correspondence Address: BACON & THOMAS, PLLC, 625 SLATERS LANE, FOURTH FLOOR, ALEXANDRIA, VA, 22314, US

(73) Assignee: Sunplus Technology CO., Ltd., Hsinchu (TW)

(21) Appl. No.: 11/439,274

(22) Filed: May 24, 2006

(30) Foreign Application Priority Data
Aug. 3, 2005 (TW) 094126328

(51) Int. Cl. G06F 13/38

(52) U.S. Cl. 710/62

(57) ABSTRACT

A USB apparatus capable of automatically detecting a USB mode and the method thereof, which determines the USB apparatus to act as a host or device function in accordance with electrical signals on two connective ports and uses an internal or external switch to route USB signals to an appropriate connection port. Therefore, a user can connect the USB apparatus with other OTG-USB apparatuses or a typical USB host or device without preparing any additional cables, and a mode of the USB apparatus is automatically detected and set to thus increase the convenience in usage.

### BACKGROUND OF THE INVENTION

1. Field of the Invention

The invention relates to the technical field of universal serial bus (USB) and, more particularly, to a USB apparatus capable of automatically detecting a USB mode and the method thereof.

2. Description of Related Art

A conventional USB apparatus can be employed to play either a host function or a device function. The personal computer and set-top box (STB) are grouped into the host function mode while the thumb drive and MP3 player are grouped into the device function mode, while the roles of which cannot be changed.

FIG. 1 is a block diagram of a conventional USB apparatus 100 with both the host function and device function. As shown in FIG. 1, the apparatus 100 uses a host physical layer 110 to implement the host function through a host port 120, which can be an A receptacle or a mini-A receptacle. The apparatus 100 also uses a device physical layer 130 to implement the device function through a device port 140, which can be an A plug, a B receptacle or a mini-B receptacle. However, due to using two physical layers, it increases not only the required die area but also the cost. In addition, the host function and the device function mostly not work concurrently, i.e., only one physical layer can work at a time, and thus the resources of hardware are wasted.

In the On-The-Go (OTG) specification of USB, an OTG-USB apparatus can be switched between the host and the device functions. However, a mini-AB cable defined by the OTG specification cannot be compatible with a conventional USB cable, and a user has to prepare multiple cables for connecting with other OTG-USB apparatus or a typical USB apparatus, which is inconvenient.

To overcome the aforementioned problem, FIG. 2 is a block diagram of a USB apparatus 200 with A and B receptacles. As shown in FIG. 2, the USB apparatus 200 includes an OTG physical layer 210, a host port 220, a device port 230, switches 240, 250 and a DIP switch 260. When the DIP switch 260 is set to a first position, signals DP, DM of the OTG physical layer 210 are connected to the host port 220 to thus implement the host function. When the DIP switch 260 is set to a second position, signals DP, DM of the OTG physical layer 210 are connected to the device port 230 to thus implement the device function. Such a way can eliminate the requirement of using two cables, but a user has to know that the USB apparatus 200 performs on the host or device function, and accordingly turns the switch 260 to an appropriate position, which also results in an inconvenience. Therefore, it is desirable to provide an improved USB apparatus capable of automatically detecting a USB mode and the method thereof to mitigate and/or obviate the aforementioned problems.

### SUMMARY OF THE INVENTION

The object of the invention is to provide a USB apparatus capable of automatically detecting a USB mode, which can overcome the prior problem that two cables are required in connecting with other OTG-USB apparatus or a typical USB apparatus.

In accordance with one aspect of the present invention, there is provided a universal serial bus (USB) apparatus, which has a host function and a device function. The apparatus includes a physical layer, a host port, a device port and a switch. The physical layer receives and sends USB electrical signals, and converts the USB electrical signals into corresponding signals. The host port has USB pins to connect to an external USB apparatus, and receives USB electrical signals from or transmits USB electrical signals to the external USB apparatus that is connected to the host port via the USB pins. The device port has USB pins to connect to a USB host, and receives USB electrical signals from or transmits USB electrical signals to the USB host by the USB pins. The switch is coupled to the physical layer, the host port and the device port in order to connect the USB electrical signals of the physical layer to the USB pins of the host or device port; wherein the physical layer determines the USB apparatus to act as the host function or the device function in accordance with the USB electrical signals of the USB pins of the host and device ports, and uses the switch to switch the USB electrical signals of the physical layer to the USB pins of a corresponding port.

In accordance with another aspect of the present invention, there is provided a method of automatically detecting USB modes, which is used in USB apparatus having a physical layer for receiving and transmitting USB electrical signals and converting the USB electrical signals into corresponding signals, a host port for connecting to a first external USB apparatus with device mode, and a device port for connecting to a second external USB apparatus with host mode. The method of automatically detecting USB modes for the USB apparatus detects whether the USB apparatus acts in a host mode or a device mode, the method comprising the steps of: (A) setting the USB apparatus to the host mode; (B) detecting USB electrical signals on USB pins of the host port and the device port for determining whether the host port or the device port connects to an external USB apparatus; and (C) switching the USB apparatus from the host mode to the device mode when step (B) decides that the device port is connected to the second external USB apparatus with host mode.

Other objects, advantages, and novel features of the invention will become more apparent from the following detailed description when taken in conjunction with the accompanying drawings.

### BRIEF DESCRIPTION OF THE DRAWINGS

FIG. 1 is a block diagram of a typical USB apparatus with a host function and a device function;

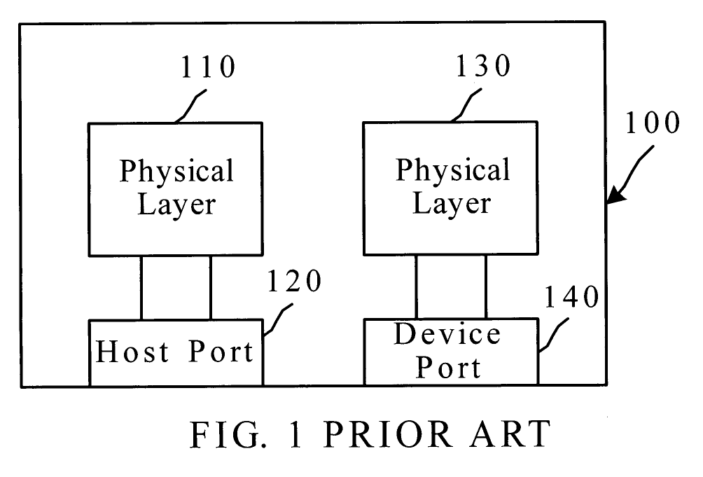

FIG. 2 is a block diagram of a typical OTG-USB apparatus with host and device ports;

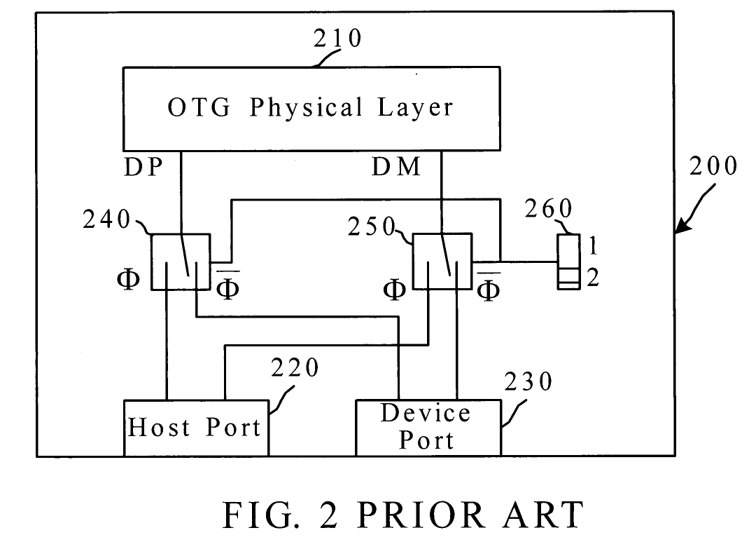

FIG. 3 is a block diagram of a USB apparatus capable of automatically detecting a USB mode in accordance with the invention;

FIG. 4 is a flowchart of an embodiment used in the USB apparatus of FIG. 3 in accordance with the invention; and

FIG. 5 is a flowchart of another embodiment used in the USB apparatus of FIG. 3 in accordance with the invention.

### DETAILED DESCRIPTION OF THE PREFERRED EMBODIMENT

The invention provides a USB apparatus capable of automatically detecting a USB mode and the method thereof, which determines the USB apparatus to act as a host or device function in accordance with electrical signals on two connective ports and uses an internal or external switch to connect USB signals to an appropriate port without any user operation, to thus increase the convenience in usage.

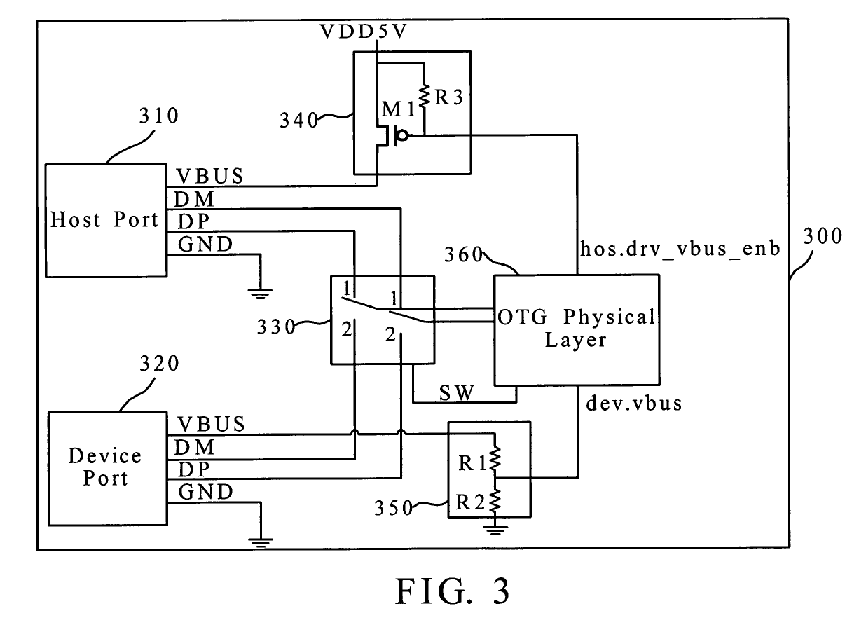

FIG. 3 is a block diagram of a USB apparatus 300 capable of automatically detecting a USB mode in accordance with the invention. As shown in FIG. 3, the USB apparatus 300 includes a host port 310, a device port 320, a switch 330, a host port power enabling circuit 340, a device port power detecting circuit 350 and an On-The-Go (OTG) physical layer 360.

When the USB apparatus 300 acts as the host function, the host port 310 is used to connect to a different USB apparatus (not shown) acting as a device function. The host port 310 can be an A receptacle or a mini-A receptacle.

When the USB apparatus 300 acts as a device function, the device port 320 is used to connect to a USB host (not shown). The device port 320 can be a B receptacle, a mini-B receptacle or an A plug.

As shown in FIG. 3, when the switch 330 is switched to the position ‘1’ by a control signal SW, the signal DP and the signal DM of the OTG physical layer 360 are connected to the respective signal DP and the respective signal DM of the host port 310. When the switch 330 is switched to the position ‘2’ by the control signal SW, the signals DP and DM of the OTG physical layer 360 are connected to the respective signals DP and DM of the device port 320.

The host port power enabling circuit 340 is coupled between the host port 310 and the physical layer 360 in order to provide power for the USB apparatus connected to the host port 310. The circuit 340 is a control circuit to control whether to supply power to the host port 310 or not. The circuit 340 has a PMOS transistor M1 and a resistor R3. When the OTG physical layer 360 determines that the USB apparatus 300 acts as the host function, it outputs a low-potential control signal hos.drv_vbus_enb to turn on the transistor M1. At this point, the power VDD5V is provided to the USB apparatus connected to the host port 310 through the signal VBUS of the first host port 310.

The device port power detecting circuit 350 detects whether the device port 320 is connected to a host (not shown) or not through a signal VBUS provided by the host, wherein the signal VBUS is 5V The device port power detecting circuit 350 essentially produces an acceptable potential for the physical layer 360 to thus avoid a damage of the physical layer 360 from an inappropriate high voltage. The circuit 350 has a resistor R1 and a resistor R2 to detect whether the device port 320 connects to a USB host or not. When the device port 320 connects to the USB host, the signal VBUS of the device port 320 goes to a high potential. At this point, the high-potential signal VBUS is output to the device port power detecting 350 to thus produce a high potential signal dev.vbus to be output to the OTG physical layer 360. Accordingly, the OTG physical layer 360 can determine the USB apparatus 300 acting as the device function. In this case, the OTG physical layer 360 outputs a high impedance to the control signal hos.drv_vbus_enb for controlling the resistor R3 to turn the transistor M1 off and outputting the control signal SW to connect the signal DM and the signal DP of the OTG physical layer 360 to the signal DM and the signal DP of the device port 320 respectively, i.e., the connection is changed to position ‘2’.

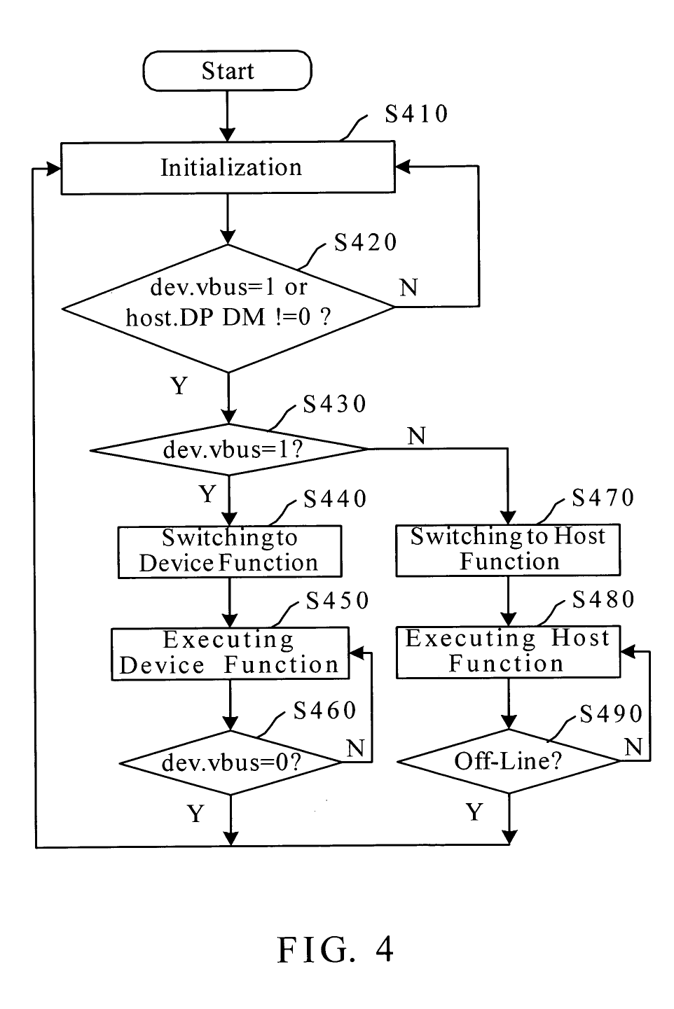

FIG. 4 is a flowchart of an embodiment used in the USB apparatus of FIG. 3 in accordance with the invention. As shown in FIG. 4, step S410 performs an initialization. Namely, the OTG physical layer 360 outputs a low-potential control signal hos.drv_vbus_enb to turn the transistor M1 on. At this point, the USB apparatus 300 acts as the host function.

Step S420 determines if the host port 310 or device port 320 connects to a different USB apparatus; if yes, step S430 is executed, and otherwise step 410 is repeated. In this case, step S420 determines if the signal dev.vbus is at a high potential (1) or the signal DM or the signal DP of the host port 310 is not at a low potential (0).

Step S430 determines the USB apparatus 300 to act as a host function or a device function. Step S430 first determines if the signal dev.vbus for the device port 320 is at a high potential (1); if yes, step S440 is executed; and if not, step S470 is executed. In step S440, which indicates the USB apparatus 300 to act as the device function, the OTG physical layer 360 outputs a high-impedance control signal hos.drv_vbus_enb to control the resistor R3 to turn the transistor M1 off. In step S450, the USB apparatus 300 acts as the device function. Step S460 determines if the signal dev.vbus is at a low potential (0); if yes, it indicates that the USB apparatus connected to the device port 320 is removed and step S410 is executed; and if not, step S450 is executed.

In step 470, which indicates the USB apparatus 300 to act as the host function, the OTG physical layer 360 outputs a low-potential control signal hos.drv_vbus_enb to turn the transistor M1 on. In step S480, the USB apparatus 300 acts as the host function. Step S490 determines if the USB apparatus connected to the host port 310 is removed; if yes, step S410 is executed; and if not, step S480 is executed.

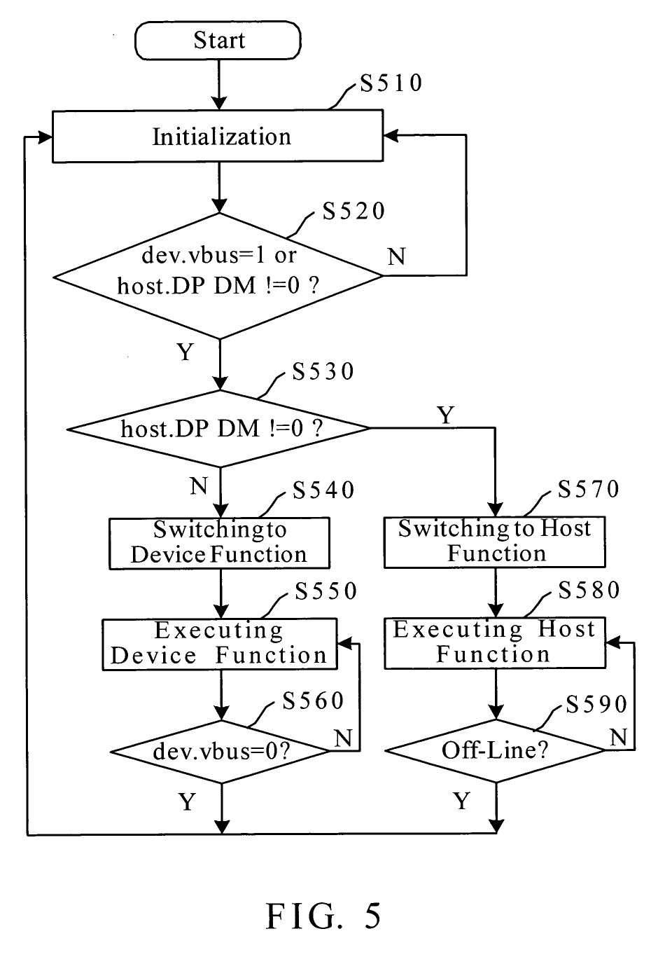

FIG. 5 is a flowchart of another embodiment used in the USB apparatus of FIG. 3 in accordance with the invention. As compared to FIG. 4, the only difference is in step S530, which determines the USB apparatus 300 to act as a device or host function in accordance with the signal DM or the signal DP of the host port 310.

In view of the foregoing, it is known that the invention determines the USB apparatus 300 to act as a host or device function in accordance with electrical signals of the host port 310 and the device port 320 and uses an internal or external switch 330 to route USB signals to an appropriate connective port. These cited operations are not involved by a user. In addition, the USB apparatus 300 can connect to other OTG-USB apparatus or a typical USB host or device without preparing additional cables by the user, to thus increase the convenience in usage.

Although the present invention has been explained in relation to its preferred embodiment, it is to be understood that many other possible modifications and variations can be made without departing from the spirit and scope of the invention as hereinafter claimed.

What is claimed is:

1. A universal serial bus (USB) apparatus, which has a host function and a device function, the apparatus comprising:
a physical layer, which receives and transmits USB electrical signals and converts the USB electrical signals into corresponding signals;
a host port, which has USB pins to connect to an external USB apparatus and receives USB electrical signals from or transmits USB electrical signals to the external USB apparatus that is connected to the host port via the USB pins;
a device port, which has USB pins to connect to a USB host and receives USB electrical signals from or transmits USB electrical signals to the USB host by the USB pins; and
a switch, which is coupled to the physical layer, the host port, and the device port in order to connect the USB electrical signals of the physical layer to the USB pins of the host port or the device port;
wherein the physical layer determines the USB apparatus to act as the host function or the device function in accordance with the USB electrical signals of the USB pins of the host and device ports, and uses the switch to switch the USB electrical signals of the physical layer to the USB pins of a corresponding port.

2. The USB apparatus as claimed in claim 1, further comprising:
a device port power detecting circuit, which is coupled between the device port and the physical layer in order to detect whether the device port is connected to the USB host or not.

3. The USB apparatus as claimed in claim 1, further comprising:
a host port power enabling circuit, which is coupled between the host port and the physical layer in order to provide power for the external USB apparatus connected to the host port.

4. The USB apparatus as claimed in claim 1, wherein the physical layer is an On-The-Go (OTG) physical layer.

5. The USB apparatus as claimed in claim 1, wherein the switch is implemented inside the physical layer.

6. The USB apparatus as claimed in claim 1, wherein the host port is an A receptacle or a mini-A receptacle.

7. The USB apparatus as claimed in claim 1, wherein the device port is selectively to be a B receptacle, a mini-B receptacle and an A plug.

8. In an universal serial bus (USB) apparatus having a physical layer for receiving and transmitting USB electrical signals and converting the USB electrical signals into corresponding signals, a host port for connecting to a first external USB apparatus with device mode, and a device port for connecting to a second external USB apparatus with host mode, a method of automatically detecting USB modes for the USB apparatus, which detects whether the USB apparatus acts in a host mode or a device mode, the method comprising the steps of:
(A) setting the USB apparatus to the host mode;
(B) detecting USB electrical signals on USB pins of the host port and the device port for determining whether the host port or the device port connects to an external USB apparatus; and
(C) switching the USB apparatus from the host mode to the device mode when step (B) decides that the device port is connected to the second external USB apparatus with host mode.

9. The method as claimed in claim 8, wherein step (B) detects VBUS signal of the device port for determining whether the device port connects to the external USB apparatus.

10. The method as claimed in claim 9, wherein it determines that the device port connects to the external USB apparatus when VBUS signal of the device port is at a high potential.

11. The method as claimed in claim 8, wherein step (B) detects a DM signal or a DP signal of the host port for determining whether the host port connects to the external USB apparatus.

12. The method as claimed in claim 11, wherein it determines that the host port connects to the external USB apparatus when the DM signal or the DP signal of the host port is not at a low potential.

13. The method as claimed in claim 8, wherein the host port is selectively to be an A receptacle or a mini-A receptacle.

14. The method as claimed in claim 8, wherein the device port is selectively to be a B receptacle, a mini-B receptacle and an A plug.
